(19) United States
(12) Patent Application Publication
(10) Pub. No.: US 2017/0108205 A1
(43) Pub. Date: Apr. 20, 2017

(54) ENCAPSULATED LIGHT FIXTURE

(71) Applicant: The Original Cast Lighting, Inc., St. Louis, MO (US)

(72) Inventor: Andrew Schainker, St. Louis, MO (US)

(73) Assignee: THE ORIGINAL CAST LIGHTING, INC., St. Louis, MO (US)

(21) Appl. No.: 14/883,230

(22) Filed: Oct. 14, 2015

(51) Int. Cl. F21V 31/04; F21V 29/83; F21V 7/00; F21V 23/00

(52) U.S. Cl. CPC F21V 31/04; F21V 23/003; F21V 29/83; F21V 7/005; F21Y 2101/02; F21Y 2103/003

(57) ABSTRACT

An encapsulated light fixture is provided that may be mounted to a ceiling or a wall. Multiple light fixtures may be connected with one another to provide for lighting a greater area. The light fixture may include a housing unit that secures a driver housing assembly and an LED light assembly. The LED light assembly is attached to the housing unit and includes an LED array that is secured by an encapsulation member. The encapsulation member is preferably formed of a transmissive urethane epoxy. LED lights associated with the LED light assembly may illuminate through the encapsulation member. By utilizing the encapsulation member, moisture and other particulates which may damage components of the light fixture are preferably prevented from entering and damaging the fixture.

### BACKGROUND OF INVENTION

When constructing light fixtures, particularly for wet or dusty environments, LED strips and associated circuitry are often enclosed within a housing for shielding the circuitry from particles, liquid, and other potential irritants found in the environment that may damage the circuitry. Gaskets and other sealing methodologies that are currently used to help prevent damage to the LED strips and associated circuitry are susceptible to damage in the field during installation and maintenance. Installation is often time consuming, and the gaskets or seals often used are not always adept at preventing damage to components within the fixture.

The gaskets and other seals commonly used may also be prone to loosening and/or breaking which may also lead to outside particles and/or materials entering the light fixture and potentially causing damage to components within the light fixture. The efficacy of the gaskets and/or seals is only as good as the materials or the fastening devices associated with the light fixtures.

Differing thermal expansion rates for the various materials which form and seal the housing of a light fixture can result in cracks which may break the environmental seal. Additionally, the housing that is often used in the art usually include a lens portion through which lights associated with the light fixture radiate from the housing. Such lenses are also susceptible to damage and subsequent failure. The lenses are often in need of replacement, and the assembly of such housings including the lenses may also require complex assembly. A more simple, less susceptible to damage solution is therefore desired.

### SUMMARY OF INVENTION

The present invention relates to an encapsulated light fixture for being mounted on or in a wall, ceiling, or otherwise, either recessed or directly abutting the wall or ceiling. The light fixture preferably includes a housing unit that may be attached to the ceiling or wall. The housing unit may be releasably engaged with adjacent housing units so as to form a row of lighting. Such lighting may be linear, angled, curved, or the like, as desired.

The housing unit may also secure a housing assembly for securing a power source and other electronic driver components therein. The housing assembly may be engaged with the housing unit in a manner known in the art, for example by friction fit. Alternatively, other securing structures may be used, such as a cable assembly to provide for a safety mechanism to prevent the assembly from falling on a person or equipment below the light fixture.

An LED light assembly may further be provided within the housing unit, either next to or below the housing assembly. The housing assembly is preferably in electronic communication with the LED light assembly so as to provide components of the LED light assembly with power and other electronic communications. The LED light assembly preferably includes a frame member that is releasably attachable with the housing unit, for example by fastening clips. An LED array may be positioned and located below the frame member. The LED array is preferably in electronic communication with the housing assembly.

An encapsulation member is preferably provided that is supported by the frame member. The encapsulation member may be formed from a two-part transmissive urethane epoxy that is preferably mixed such that it hardens in place after being poured into the housing unit to cover the frame member and/or the LED light assembly within the frame member. The encapsulation member preferably encapsulates the frame member and/or the LED light assembly, preferably sealing the LED array from the potentially harmful effects of liquids and particles. The encapsulation member also preferably allows the LED array member to illuminate through the encapsulation member so as to use the encapsulation member as a lens.

Thus, because of the use of the encapsulation member, a special lens may be unnecessary. Lights associated with the LED array may illuminate through the encapsulation member, which may itself act as a lens, such as a diffusion lens. No additional gaskets or seals may be necessary, because the material of the encapsulation member is preferably able itself to mold and form a one-piece seal.

### DESCRIPTION OF THE SEVERAL VIEWS OF THE DRAWINGS

In the accompanying drawings, which form a part of the specification and are to be read in conjunction therewith in which like reference numerals are used to indicate like or similar parts in the various views:

FIG. 1 illustrates an exploded view and an encapsulated light fixture according to the teachings of the present invention.

FIG. 2 illustrates an alternative exploded view of the encapsulated light fixture of FIG. 1.

FIG. 3 illustrates a cross section view of the encapsulated light fixture of FIGS. 1 and 2.

### DETAILED DESCRIPTION OF THE INVENTION

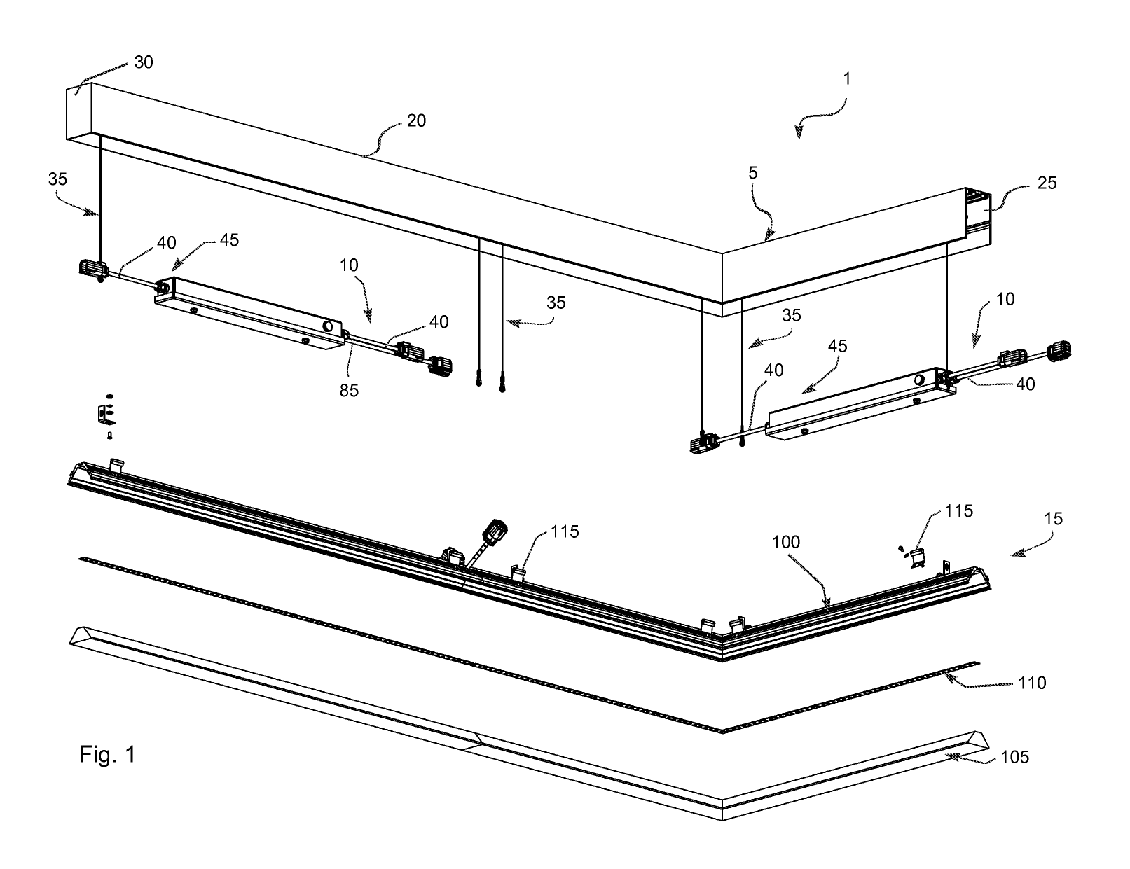

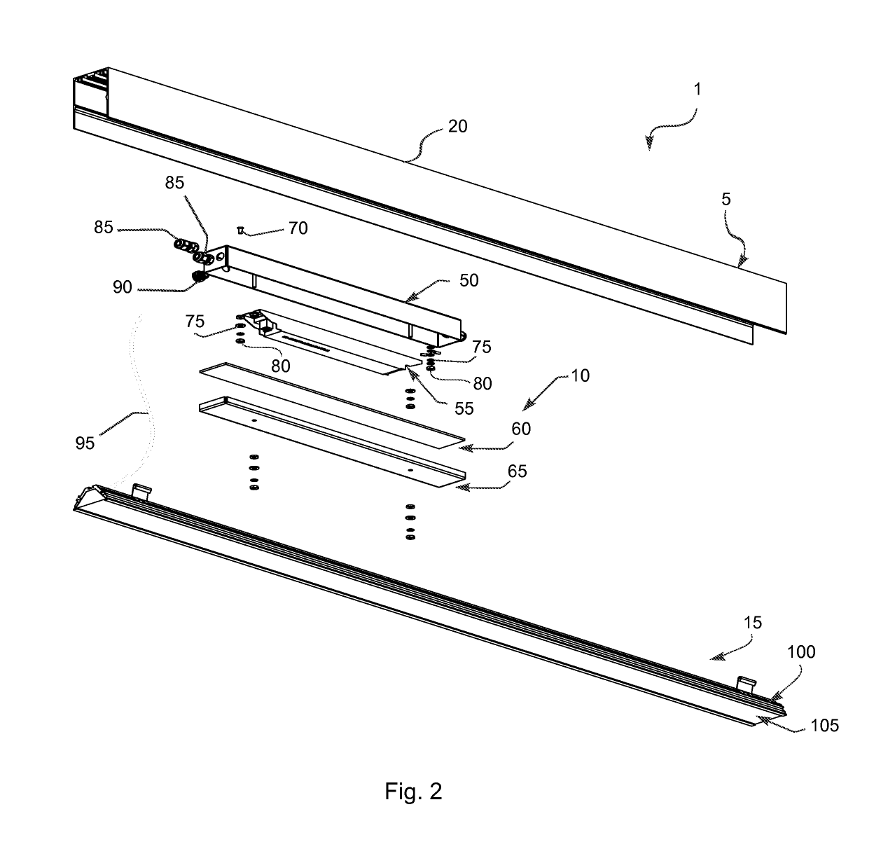

FIGS. 1 and 2 illustrate an encapsulated light fixture 1 in its disassembled configuration.

Light fixture 1 generally may comprise a housing unit, or housing 5, which may be constructed of aluminum or a similar metal, or even a plastic or the like. The light fixture 1 may also include one or more than one housing assembly 10 and light assembly 15. Housing assembly 10 is illustrated as exploded in FIG. 2 to show its example components in greater detail, and LED light assembly 15 is illustrated as exploded in FIG. 1 to illustrate its example components in greater detail.

An upper portion 20 of housing 5 may be attached to a ceiling or an outer perimeter of a portion of a wall in a manner long known and understood in the art, for example by nailing or otherwise fastening housing 5 to such a surface. Housing 5 illustrated in FIGS. 1-3 is illustrative only. As will be understood, housing 5 may take many shapes and sizes. As commonly understood in the art, several housings 5 may be releasably attached to one another to form a longer and/or larger encapsulated light fixture 1 to cover a greater surface area and to provide more light to an inside or outside environment. Housing 5 to be attached with other housings 5 may include an open portion 25 as shown in FIG. 1 for releasable attachment with another open portion 25 of an additional housing 5. When housing 5 is located such that it will not be attached to another housing 5, it may include an encapsulating cap member 30 such as that shown in FIG. 1 to give housing 5 a more finished appearance.

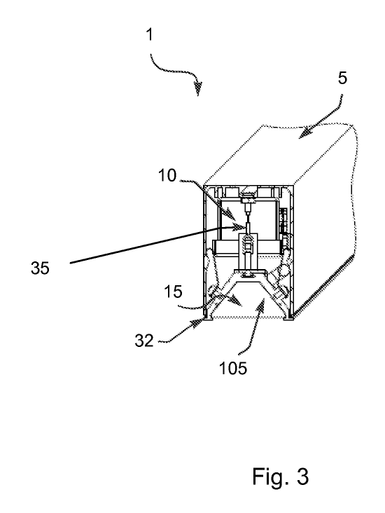

Housing 5 may further include a rear reflector 32, which is shown in the cross section view of light fixture 1 of FIG. 3. Rear reflector 32 preferably reflects light outwardly and may be fabricated, formed, or extruded from a metal or other appropriate material.

Rear reflector 32 may be attached to housing 5 in any conventional manner, and may be secondarily connected to housing via a cable assembly 35 as a fail-safe. Rear reflector 32 may be attached to housing 5 via cable assembly 35 such that if rear reflector 32 and/or housing assembly 10 become disengaged from housing 5, cable assembly 35 may prevent rear reflector 32 and/or housing assembly 10 from falling and potentially injuring a person standing below light fixture 1. In some embodiments, housing assembly 10 may be releasably engaged with housing 5 via a friction fit, by way of fastening (e.g, via screws or bracket members), or other known or foreseeable means to those skilled in the art. In the preferred embodiment, housing assembly 10 and housing 5 are releasably engaged via a screw mechanism.

Housing assembly 10 is shown as an assembled in FIG. 1, and is shown in greater detail as exploded in FIG. 2. As shown in FIG. 2, housing assembly 10 generally comprises an LED driver enclosure 50, an LED driver 55, a gasket 60, and an LED driver enclosure cover 65. Driver enclosure 50 may serve to house and secure LED driver 55. LED driver 55 may be of the type commonly known and used in the industry. An LED driver such as LED driver 55 may include a power source (not illustrated) and other electronic circuit components (not illustrated) that are typically utilized in an LED driver. Housing assembly 10 may be secured within housing 5 via not only cable assembly 35 but also a simple screw mechanism or other attachment means such as screws 70, washers 75, and nuts 80 as shown and illustrated in FIG. 2.

LED driver enclosure 50 may further include liquid tight cord grips 85 which may receive and secure cord numbers 40 associated with cable assembly 35. Cord grips 85 are preferably liquid tight so as to prevent any moisture, liquid, or other debris from entering LED driver enclosure 50 and potentially damage the various electrical components contained therein. Driver enclosure 50 may further include a breather vent 90 for allowing LED driver enclosure 50 to vent any excess heat generated by LED driver 55, so as to help prevent LED driver 55 from overheating.

As shown in FIG. 2, a low voltage cord 95 may connect electronic components of LED driver 55 with electronic components discussed herein that are preferably housed within LED light assembly 15. LED light assembly 15 is illustrated as assembled in FIG. 2, and is illustrated in an exploded view in greater detail in FIG. 1. As shown in FIG. 1, light assembly 15 generally comprises a frame member 100, an encapsulation member 105, and an LED array member 110 positioned and located between frame member 100 and encapsulation member 105. The encapsulation member 105 may be composed of urethane or the like. It should be noted that reference is made repeatedly to an LED light source, though other types of light sources (and electronic components) may be used with light fixture 1.

Rear reflector 32 may be formed as the outwardly directed face of frame member 100. Frame member 100 may further include spring fastening clips 115 for selective engagement with aluminum housing 5 when encapsulated light fixture 1 is assembled. Utilizing fastening clips 115 to selectively engage aluminum housing 5 and frame member 100 is preferred, however any foreseeable means of selectively engaging light assembly 15 within housing 5 is foreseeable. Encapsulation member 105 may be formed from a two-part resin, or transmissive urethane epoxy that is preferably mixed and poured onto the LED array member 110 within the frame member 100 such that it hardens. The two-part epoxy may be poured in either one or two stages, depending on the final application to allow for a consistent, evenly illuminated surface visibly similar to opal acrylic. The encapsulating process that may be utilized allows for light fixture 1 to be useful in wet locations either indoor or outdoor and maintain its functionality in either environment. Other encapsulation member 105 materials are also envisioned.

Encapsulation member 105 may completely encapsulate LED array member 110 within frame member 100, and thus protect the LED array member 110 from the effects of liquids and particles. In another embodiment, encapsulant may also be positioned between the housing 5 and frame member 100, such that encapsulation member 105 also encapsulates LED driver 55 and/or other components. In some embodiments, encapsulation member 105 may encapsulate frame member 100, thereby encapsulating any components therein, such as LED array 110. Encapsulation member 105 may form a barrier between the outside environment and various components within housing 5. Thus, an endcap may not be necessary to enclose the ends of housing 5, for example when abutting another lighting fixture. A series of at least two fixtures 1 may therefore be placed end-to-end without the use of endcaps on their abutting ends. Thereby, encapsulation member 105 may protect the LED array 110 and/or other components from the effects of outside influences, but also may allow for LED array member 110 to provide an even illumination that does not generate endcap dark spots or shadows. When placed end-to-end in this manner, the illumination of such a series of fixtures 1 may appear continuous, rather than broken by endcaps.

Because of the use of encapsulation member 105, a special lens may be unnecessary. Lights associated with array member 110 may illuminate through encapsulation member 105, which may itself act as a lens, such as a diffusion lens. Preferably, no additional gaskets or seals are necessary, because the epoxy of encapsulation member 105 is preferably able itself to mold and form a one-piece seal. FIG. 3 illustrates a cross section view of encapsulated light fixture 1 when assembled. Various components and elements of light fixture 1 discussed hereinabove are illustrated in greater detail in FIG. 3.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An encapsulated light fixture for illuminating an indoor or outdoor environment, the light fixture comprising:
a housing unit;
an encapsulation member contained in said housing unit; and
a light source positioned between said housing unit and said encapsulation member, wherein said encapsulation member seals said light source from the external environment, and wherein said encapsulation member acts as a lens through which light from said light source is shone.

2. The light fixture of claim 1, wherein the light fixture includes a driver housing for providing power to the light source.

3. The light fixture of claim 1, wherein the light source is an LED array.

4. The light fixture of claim 1, wherein the encapsulation member is a two-part epoxy.

5. The light fixture of claim 1, wherein the encapsulation member includes a urethane.

6. The light fixture of claim 1, wherein the housing unit includes a frame member with a rear reflector for reflecting light outwardly from the light source.

7. The light fixture of claim 6, wherein the light source is positioned between the frame member and the encapsulation member, wherein the encapsulation member encapsulates the frame member and the light source.

8. The light fixture of claim 2, wherein the driver housing includes an LED driver.

9. The light fixture of claim 2, wherein the driver housing includes a breather vent for decreasing heat generated in the driver housing.

10. The light fixture of claim 1, wherein the encapsulation member is secured by a frame member.

11. An encapsulated light fixture system for illuminating an indoor or outdoor environment, the system comprising:
at least two light fixtures, each including:
a housing unit having opposing ends, wherein at least one of said opposing ends is capless;
a light source positioned within said housing unit;
an encapsulation member contained in said housing unit and encapsulating the light source to seal the light source against an external environment, wherein said encapsulation member acts as a lens through which light from said light source is reflected;
wherein said at least two light are installed with the respective capless ends of each light fixture abutting, such that the system illuminates through the encapsulation member and capless ends without generating a endcap shadow.

12. The light fixture of claim 11, wherein the light source is an LED array.

13. The light fixture of claim 11, wherein the encapsulation member is a two-part epoxy.

14. The light fixture of claim 11, wherein the encapsulation member includes a urethane.

15. The light fixture of claim 11, wherein the housing unit includes a frame member with a rear reflector for reflecting light outwardly from the light source.

16. The light fixture of claim 15, wherein the light source is positioned between the frame member and the encapsulation member, wherein the encapsulation member encapsulates the frame member and the light source.

17. The light fixture of claim 11, further including a driver housing, said driver housing including an LED driver.

18. The light fixture of claim 11, wherein the driver housing includes a breather vent for decreasing heat generated in the driver housing.

19. The light fixture of claim 11, wherein the encapsulation member is secured by a frame member.

20. The light fixture of claim 17, wherein the driver housing includes a gasket for containing the LED driver.
